(19) United States
(12) Patent Application Publication
(10) Pub. No.: US 2013/0024018 A1
(43) Pub. Date: Jan. 24, 2013

(54) MULTIMEDIA CONTROL METHOD AND MULTIMEDIA CONTROL SYSTEM

(71) Applicants: Ruey-Jer Chang, Taoyuan County (TW); Zih-Ci Lin, Taoyuan County (TW); Wei-Chung Yang, Taoyuan County (TW)

(72) Inventors: Ruey-Jer Chang, Taoyuan County (TW); Zih-Ci Lin, Taoyuan County (TW); Wei-Chung Yang, Taoyuan County (TW)

(73) Assignee: HTC CORPORATION, Taoyuan County (TW)

(21) Appl. No.: 13/527,599

(22) Filed: Jun. 20, 2012

Related U.S. Application Data
(60) Provisional application No. 61/510,501, filed on Jul. 22, 2011.

(51) Int. Cl. G06F 17/00

(52) U.S. Cl. 700/94

(57) ABSTRACT

A multimedia control method is provided, which includes the following steps. Communicate a mobile device with at least one audio device. Determine at least one relative location between the mobile device and at least one of the audio device. Control the at least one audio device according to the at least one relative location.

### CROSS-REFERENCE TO RELATED APPLICATION

This application claims the priority benefit of U.S. Provisional Application Ser. No. 61/510,501, filed Jul. 22, 2011. The entirety of the above-mentioned patent application is hereby incorporated by reference herein and made a part of this specification.

### BACKGROUND OF THE INVENTION

1. Field of the Invention

The present invention relates to a multimedia control method and a multimedia control system. More particularly, the present invention relates to a multimedia control method and a multimedia control system according to the relative locations or the relative distances between related devices.

2. Description of the Related Art

Entertainment is part of people's daily life. As the growing of consumer electronics, a great variety of entertainment devices are provided in the market, such as television, DVD/CD player, etc. Those devices can be integrated or connected together to form a home entertainment system. FIG. 1 illustrates an example of home entertainment system. The system comprises a TV 110 for displaying image/video, a DVD player 120, a CD player 130, and an audio speaker set 140. In addition to above listed devices, the system may comprise other devices such as game console, fitness training equipment and/or other devices.

Currently, mobile devices such as smart phone or tablet are now integrating more functions with other electronic devices. Those devices may be connected by hardwire or wirelessly. Wireless connection may be implemented via various protocols, such as Digital Living Network Alliance (DLNA), Bluetooth, IrDa, and/or others. Mobile devices may serve to provide contents to home entertainment appliances, for example playing a movie on TV, or playing music by audio speakers. Mobile devices can further be used to control other electronic devices, for example changing TV channels. Application of integrating mobile devices with home appliances is a new field to explore.

### SUMMARY OF THE INVENTION

Accordingly, the present invention is directed to a multimedia control method and a multimedia control system, which control audio devices or multimedia devices according to their relative locations or relative distances.

According to an embodiment of the present invention, a multimedia control method is provided. The method includes the following steps. Communicate a mobile device with at least one audio device. Determine at least one relative location between the mobile device and at least one of the audio device. Control the at least one audio device according to the at least one relative location.

According to another embodiment of the present invention, a multimedia control method is provided. The method includes the following steps. Connect the mobile device to a multimedia device wirelessly. Send multimedia data to the multimedia device for output. Determine a relative distance to the multimedia device according to a wireless signal received from the multimedia device. Control the output of the multimedia data on the multimedia device.

According to another embodiment of the present invention, a multimedia control system is provided. The multimedia control system includes a wireless interface unit configured to receive a wireless signal, a processing unit configured to determine location information according the wireless signal, and a control unit configured to determine control operation according to the location information.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing a conventional home entertainment system.

FIG. 2 is a schematic diagram showing a multimedia system according to an embodiment of the present invention.

FIG. 3 is a flow chart showing a multimedia control method according to an embodiment of the present invention.

FIG. 4 is a schematic diagram showing a multimedia control system according to an embodiment of the present invention.

FIG. 5 is a table showing the relationship between signal strength and multimedia control according to an embodiment of the present invention.

FIG. 6 is another table showing the relationship between signal strength and multimedia control according to another embodiment of the present invention.

FIG. 7 is another flow chart showing a multimedia control method according to another embodiment of the present invention.

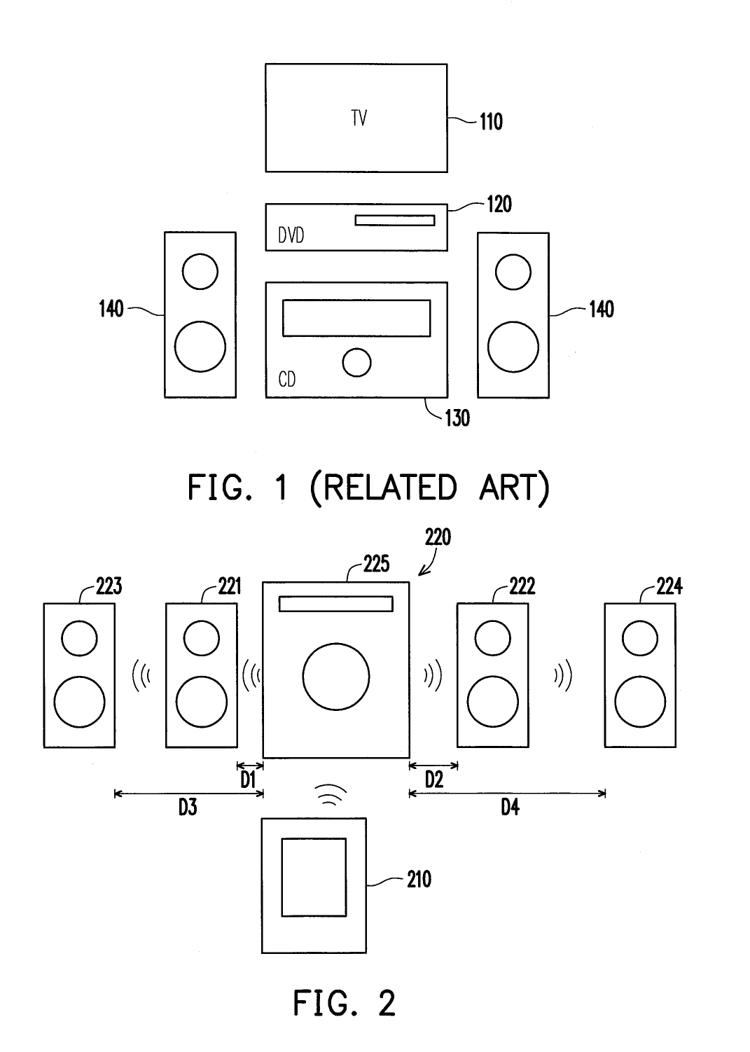

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

The invention discloses system and method for controlling multimedia output. People often carry their mobile devices with them, even at home. By detecting location of the mobile device, it can be known about the location of its owner. When a user is staying at his/her home, he/she may wish to, for example, play music or watch news on TV. As described above, home appliances are often connected together. Multimedia data may be output by a plurality of devices at the same time. The television provides image output, and the audio speaker set provides audio output, for example.

Audio speaker set may comprise one or more number of speakers. Standard 5.1 channel stereo sound system requires at least 5 speakers. However, the output volume can only be adjusted in a whole for all speakers. When user is located at a position not nearby the centre of the sound field of the audio speaker set, some channels might sound louder than others. Also, user might walk from one place to another, for example from living room to kitchen. The volume of sound may not be loud enough for user to hear clearly. The invention utilizes the mobility of mobile device for detecting relative location of mobile device to other multimedia devices, and thus controls multimedia output of the multimedia devices.

FIG. 2 illustrates an embodiment of multimedia system of the invention. As illustrated, the multimedia system comprises a mobile device 210, a multimedia player 220 having a master control unit 225 and audio speakers 221˜224. The relative distances between the master control unit 225 and the audio speakers 221˜224 are denoted as D1˜D4, respectively. The mobile device 210 may connect to the multimedia player 220 via wireless connection, such as Bluetooth or wireless network. The multimedia player 220 may be, for example DVD player, CD player, MP3/4 player and/or other type of device. The master control unit 225 may receive multimedia data and control the operation of the multimedia player 220, and the audio speakers 221˜224 are configured to output audio data. Please note that the number of audio speakers is not limited to this embodiment, it can be any other suitable number. Also, the master control unit 225 may be integrated with one or more audio speakers as a single device. The speakers 221˜224 may be connected wired or wirelessly, for example via Bluetooth.

The mobile device 210 can be configured to provide multimedia data to the multimedia player 220 and/or control the multimedia player 220. The mobile device 210 can also be configured to communicate signals with the multimedia player 220 for determining relative location of the two devices. Multimedia output of the multimedia player 220 can be controlled according to the relative location. For example, in response to the distance between the two devices is increased, output volume of the audio speakers 221˜224 can be increased. In another example, time delays of audio channels corresponding to the audio speakers 221˜224 can be adjusted accordingly so that there is no lag between the sound of audio speakers 221˜224 received by the user.

Furthermore, if the audio speakers 221˜224 can be configured as microphones for picking up audio sound, the gain of audio signal collected by the audio speakers 221˜224 may be adjusted according to the relative location.

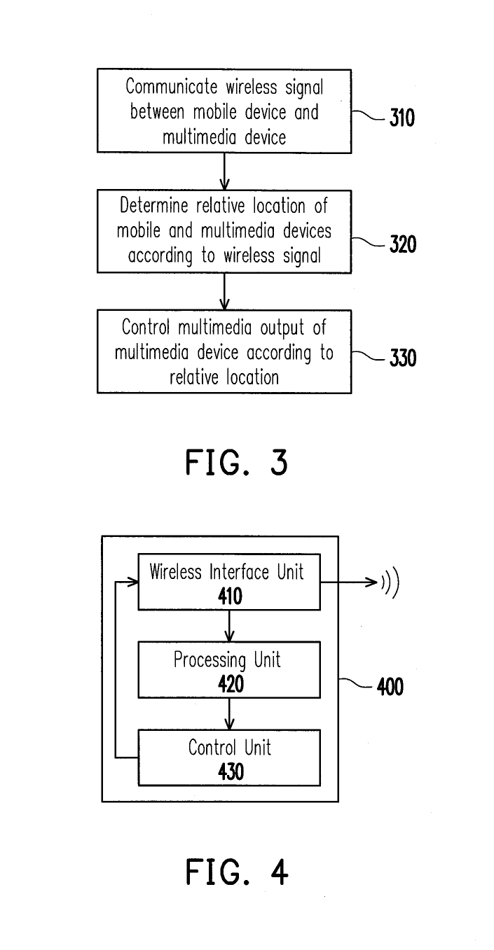

Refer to FIG. 3, which illustrates an embodiment of multimedia control method according to an embodiment of the invention. First in step 310, a wireless signal is communicated between the mobile device 210 and the multimedia device 220. The wireless signal may be used for forming connection and/or determination of presence of devices. Relative location of the mobile device and the multimedia device is then determined according to the wireless signal in step 320. In one implementation, the relative location can be determined according to signal strength of the wireless signal. As can be understood by person with ordinary skill in the art, the shorter the distance between a transmitter and a receiver is, the stronger the signal strength is. Relationship between the relative location and the signal strength can be obtained or predefined depending on the transmission protocol used, and can be stored in a memory unit. For example, if the wireless signal is transmitted via Bluetooth 4.0 or Bluetooth low energy (BLE,), the relative location can be determined according to the proximity profile of BLE. If the wireless signal is transmitted via Bluetooth lower version or other protocol such as Wi-Fi, the relative location can still be determined by predefined conversion method, such as received signal strength indicator (RSSI). Once the relative location is determined, multimedia output of the multimedia device 220 can be controlled according to the relative location in step 330. For example, adjust the audio volume or time delay of audio channels of the audio speakers 221˜224. In another implementation, the relative location may be used to control starting or stopping playback of multimedia data.

FIG. 4 illustrates a multimedia control system according to an embodiment of the invention. The multimedia control system 400 comprises a wireless interface unit 410, a processing unit 420 and a control unit 430. The wireless interface unit 410 is configured to receive and/or transmit wireless signals with other devices, such as in BLE protocol. Please be noted that other wireless protocols may be applied and is still within the scope of the invention. The wireless interface unit 410 of invention may monitors and receives wireless signals transmitted from other device, for example a multimedia device or a mobile device. The processing unit 420 receive information of the wireless signal from the wireless interface unit 410 and determines location information according to the wireless signal. Location information of the other device may be determined according to the signal strength or proximity profile in BLE of the wireless signal. In one embodiment, relationship between signal strength and relative distance may be predefined and stored in a memory unit (not shown). The processing unit 420 may determines the signal strength of the wireless signal received, and then determines the relative distance based on the relationship stored in the memory unit. The processing unit 420 transmits location information to the control unit 430 for determining corresponding operations. For example, the multimedia control system 400 may be embodied in a mobile device, and the wireless signal is received from a multimedia device. The control unit 40 may control audio output of the multimedia device, such as volume up or volume down, according to the relative distance between the mobile device and the multimedia device. The control unit 430 may provide control signals corresponding to the control operation via the wireless interface unit 410 in the case that the mobile device and the multimedia device are connected via wireless protocol.

Yet in another embodiment, the multimedia control system may be embodied in a multimedia device and receives wireless signal from a mobile device, and/or other type of device having wireless connectivity. In this embodiment, the processing unit 420 determines the relative distance to the mobile device and thus to know whether the user is moving away or closer according to the signal strength of the wireless signal received from the mobile device that the user carries with. The control unit 430 of the multimedia device may then determine whether to turn up or turn down its volume, or stop playing if the relative distance is greater than a threshold (suggesting the user is far away to see or hear the multimedia device). Other control operations may be applied as well, such as adjusting time delay of audio channel, switching playback of multimedia files, and/or more.

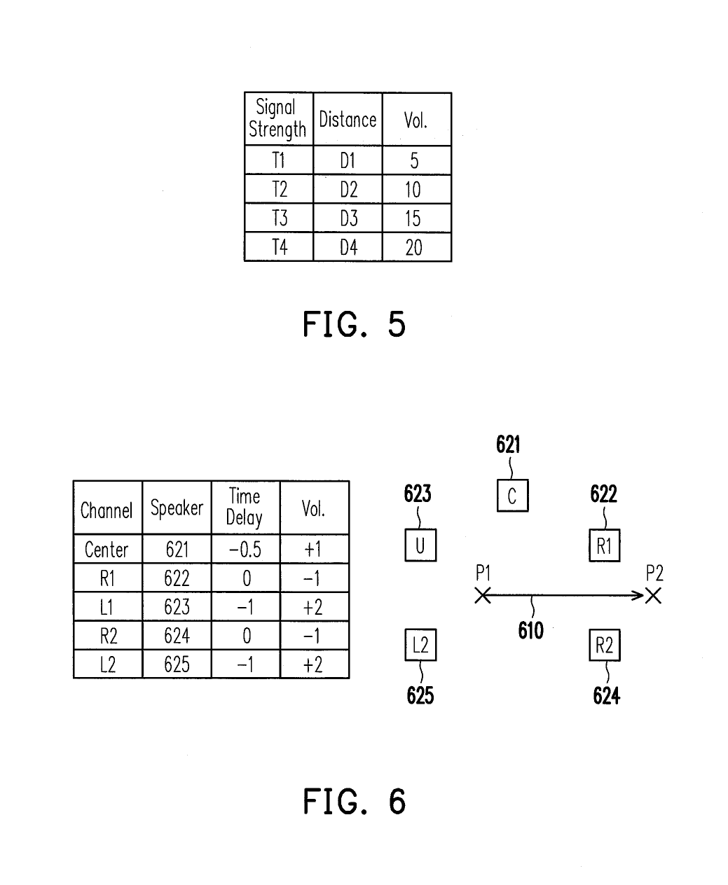

To better illustrate the concept of the invention, FIG. 5 depicts a table of an embodiment showing the relationship between signal strength and multimedia control under BLE with reference to the multimedia system of FIG. 2. In this embodiment, audio speakers 221˜224 are connected to the master control unit 225 in BLE as well. The multimedia data can be provided from the master control unit 225 directly, or from the mobile device 210 to the master control unit 225. In addition, the mobile device 210 may transmit control signal to the master control unit 225 for adjusting audio volume, changing multimedia data being played, and/or other operations. Each of the audio speakers 221˜224 receives multimedia data from the master control unit 225 as well as control signals.

According to the embodiment of the invention, the mobile device 210 may receive wireless BLE signal from each of the audio speakers 221˜224. The mobile device 210 then analyses received wireless signals for determining relative locations of the audio speakers 221˜224 according to the proximity profile. The proximity profile contains information about signal strength and corresponding distance. Once the relative locations are obtained, volume adjustment of the audio speakers 221˜224 can be determined accordingly. For example, audio speaker 221 is at a location which is D1 distance away from the mobile device 210, corresponding volume level of audio speaker 221 should be set to 5. Meanwhile, audio speaker 222 is D2 distance away, corresponding volume level of audio speaker 222 is set to 10. The relative location of each audio speaker 221˜224 can be monitored and recorded dynamically.

In another embodiment of the invention, audio volume may be adjusted when the distance changes more than a predetermined amount. For example, the audio volume remains at the same level if the distance changes less than +1 meter, and is increased by 1 level (for example 1 dB, depending on the actual design of the audio speaker) when the distance changes more than +1 meter (further away), increased by 2 levels when the distance changes more than +1.5 meter, and so on. Similarly, the volume is decreased by 1 level when the distance changes less than −1 meter (getting closer), decreased by 2 levels when the distance changes less than −1.5 meter, and so on.

In yet another embodiment of the invention, playback of multimedia data may be terminated in response to the relative location suggests the devices are away from each other greater than a threshold, or the current volume is greater than a predefined level. In this embodiment, user might be very far away from the multimedia player 220 and thus no longer needs or desires to hear the sound. Therefore, keep increasing the volume is not even necessary.

FIG. 6 illustrates another table of an embodiment showing the relationship between signal strength and multimedia control under BLE. In this embodiment, the multimedia device supports stereo sound, for example 5.1 channel, and thus there are 5 audio speakers 621˜625. The audio speakers 621˜625 are corresponding to the center channel (C), the right channel (R1), the left channel (L1), the right rear channel (R2) and the left rear channel (L2), respectively. When the mobile device 610 moves from position P1 to position P2, relative locations of the audio speakers 621˜625 as well as distances to the mobile device 610 vary in different. To provide better stereo experience, volume of each channel may be adjusted individually depending on its distance to the mobile device 610. In addition, to avoid output of the channels arrive to the listener with different time lag, time delay of each channel is adjusted individually as well.

As can be seen in FIG. 6, for the centre channel, which corresponds to audio speaker 621, distance to the mobile device 610 is changes by D1 unit. Volume of audio speaker 621 is increased by 1 level and time delay is decreased by 0.5 time unit. Therefore, the master control unit (not shown) may instruct audio speaker 621 to add output volume, and advance the audio track provided to speaker 621 by 0.5 time unit. For audio speakers 622 and 624, corresponding distances to the mobile device 610 are decreased, and thus volume of the two speakers can be decreased. Time delay of audio tracks provided to the two speakers is not adjusted due to the distance change does not significantly affect the audio delay. Please note that thresholds and adjusting levels for volume and time delay adjustments may be predefined depending on actual designs and needs, or by experiments. Adjustment of volume and time delay may be performed independently. That is, adjusting volume does not necessarily suggest the time delay should be adjusted as well, and vice versa.

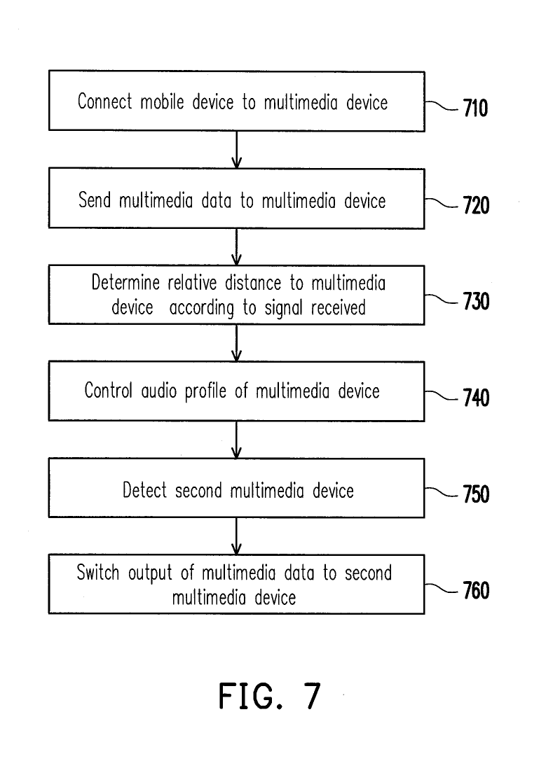

Please now refer to FIG. 7 which illustrates a multimedia control method according to another embodiment of the invention. The multimedia control method starts with connecting a mobile device to a multimedia device (step 710). The mobile device may connect to the multimedia device via wireless connection, for example Bluetooth, BLE, Near Field Communication (NFC), Wi-Fi or DLNA. Once connection is built, the mobile device sends multimedia data to the multimedia device in step 720. The multimedia data may be video data, audio data, image data, and/or combination of above. In addition, the mobile device may send control signal to the multimedia device for controlling operations of the multimedia device. For example, select a song list or a movie file for playing, forward or skip a video track, switch between songs and/or other files. The mobile device then determines relative distance to the multimedia device according to signals received from the multimedia device in step 730. The relative distance may be determined according to predefined correspondence of signal strength and distance, or according to the proximity profile (in BLE). The mobile device may monitor the relative distance dynamically or in a predefined frequency.

According to the distance determined, in step 740 the mobile device can control audio output of the multimedia device, comprising audio volume, time delay, and/or file switch, termination, etc. The multimedia device may comprise one or more audio units, such as audio speaker, microphone, amplifier, and/or other suitable units. Control of audio output may be implemented by sending a control command comprising information of audio unit identification (identification of a certain speaker, for example), volume adjustment, time delay, and/or other operation. As described above, multimedia device may comprise one or more speakers or microphones, those speakers or microphones may be controlled separately. In this embodiment, the control command would comprise identification information so as to specify which speaker should be adjusted and corresponding adjustment.

Furthermore, the mobile device may detect existence of a second multimedia device in step 750, and switch multimedia output to the second multimedia device in step 760. For example, user may have a first set of audio speakers in the living room, and a second set of audio speakers in bedroom. When user is walking around the house with the mobile device, he/she may move from one room to another. If the mobile device detects that its distance to the first set of audio speakers gets further away and its distance to the second set of audio speakers gets closer, the mobile device may switch playback of multimedia data from the first set of audio speakers to the second set of audio speakers. In another embodiment, the mobile device may gradually decrease the volume level of the first set of audio speaker and increase the volume level of the second set of audio speaker.

Yet in another embodiment, the mobile device may switch to play another multimedia file in addition to the switch of audio speakers. For example, the mobile device may control the first set of audio speakers, which are located in the living room, to play a first playlist when the mobile device is within a predefined range to the first set of audio speakers. In this case, it is assumed that the user is in the living room. In response to the mobile device detects the second set of audio speakers, which is located in bedroom, and determines that it is away from the first set of audio speakers more than the predefined range, the mobile device controls the second set of audio speakers to play a second playlist, and stops the first set of audio speakers from playback the first playlist.

It should be noted that the multimedia device of the invention is not limited to audio speaker, microphones, headphone, headset and/or other suitable devices capable to output multimedia data are within the scope of the invention.

In summary, the present invention can control playback of multimedia device according to the distance between the mobile device and the multimedia device, which synchronize the volume and time of the sound waves propagating between the user of the mobile device and the audio devices, as well as other functions such as switch of audio device or playlist.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A multimedia control method, comprising:
communicating a mobile device with at least one audio device;
determining at least one relative location between the mobile device and at least one of the audio device;
controlling the at least one audio device according to the at least one relative location.

2. The audio control method according to claim 1, further comprising:
receiving a wireless signal from the at least one audio device;
determining the distance according to signal strength of the wireless signal.

3. The audio control method according to claim 1, further comprising:
determining relative distance of each of the at least one audio device to the mobile device;
controlling volume of each of the at least one audio device according to the relative distance by the mobile device.

4. The audio control method of claim 1, wherein the controlling of the at least one audio device further comprises adjusting amplifying gain of a recording track.

5. The audio control method of claim 1, further comprising:
transmitting an audio track from the mobile device to the at least one audio device.

6. The audio control method of claim 1, wherein the controlling step further comprising:
transmitting a control signal from the mobile device to the at least one audio device.

7. The audio control method of claim 1, wherein the controlling step further comprising:
transmitting a control signal from one of the at least one audio device to the remaining of the at least one audio device.

8. The audio control method of claim 1, wherein the controlling step further comprising:
receiving a control signal at one of the at least one audio device;
transmitting the control signal to the remaining of the at least one audio device.

9. A multimedia control method for use in a mobile device, comprising:
connecting the mobile device to a multimedia device wirelessly;
sending multimedia data to the multimedia device for output;
determining a relative distance to the multimedia device according to a wireless signal received from the multimedia device; and
controlling output of the multimedia data on the multimedia device.

10. The multimedia control method of claim 9, further comprising:
connecting to a second multimedia device wirelessly;
determining a second relative distance to the second multimedia device; and
switching output of the multimedia data to the second multimedia device according to the second relative distance.

11. The multimedia control method of claim 10, wherein the switching further comprising:
terminating output of the multimedia device in response to the relative distance is greater than a predefined threshold.

12. The multimedia control method of claim 9, wherein the relative distance is determined according to a predefined relationship with signal strength.

13. The multimedia control method of claim 9, wherein the relative distance is determined according to a proximity profile of Bluetooth low energy (BLE).

14. The multimedia control method of 9, wherein the determining and the controlling are performed dynamically in a predefined basis.

15. The multimedia control method of claim 9, wherein the controlling of the multimedia data comprises at least one of the following:
adjusting volume level of the multimedia device;
adjusting time delay of the multimedia data;
switching output to another multimedia data; and
terminating output of the multimedia data.

16. A multimedia control system, comprising:
a wireless interface unit, configured to receive a wireless signal;
a processing unit, configured to determine location information according the wireless signal; and
a control unit, configured to determine control operation according to the location information.

17. The multimedia control system of claim 16, wherein the processing unit determines a relative distance to a multimedia device according to signal strength of the wireless signal received.

18. The multimedia control system of claim 17, wherein the control unit control audio output of a multimedia device according to the relative distance.

19. The multimedia system of claim 16, the control unit is further configured to provide a control signal corresponding to the control operation and multimedia data via the wireless interface unit

20. The multimedia system of claim 16, wherein the multimedia system is implemented in a mobile device and the wireless signal is in Bluetooth low energy (BLE) protocol.
